(19) United States
(12) Patent Application Publication
(10) Pub. No.: US 2021/0187430 A1
(43) Pub. Date: Jun. 24, 2021

(54) Method of Removal of Contaminants

(71) Applicants: Patrick Watson, League City, TX (US); Davide Secci, League City, TX (US)

(72) Inventors: Patrick Watson, League City, TX (US); Davide Secci, League City, TX (US)

(21) Appl. No.: 16/720,569

(22) Filed: Dec. 19, 2019

(51) Int. Cl. B01D 47/06; B60S 3/04; A62B 99/00

(52) U.S. Cl. CPC B01D 47/06; A62C 99/009; A62B 99/00; B60S 3/04

(57) ABSTRACT

The present invention relates to a method of removing contaminants from interior of a vehicle. The contaminants become suspended by an emulsification process and removed from the interior of the vehicle by a vacuum suction unit.

### FIELD OF INVENTION

The present invention relates to a method for removal of contaminants from interior of a vehicle. More specifically, the invention relates to removing contaminants such as carcinogen or other toxic compounds by an emulsification suspension process.

### BACKGROUND OF THE INVENTION

Fire fighting vehicles are used for transporting firefighters and firefighting equipment at the scene of fire or any other emergency to extinguish a fire. While extinguishing a fire, the burned materials release carcinogenic or other toxic chemicals and gases that cause cancer. Firefighters have increased exposure to the cancer-causing agents than the general public. Some measures have been taken to sterilize the fire fighter vehicles to remove the carcinogen.

An E.P. Patent EP0604698 assigned to Richard W. Krajicek, discloses the decontamination of a vessel by a solution containing extractant material and surfactant that are vaporized and heated with steam. Further the solution is agitated on the surface of the vessel for a sufficient time to allow the solution to entrap contaminants. After entrapping the solution, it is removed from the vessel thus making vessel free from the hazardous contaminants. The drawback is that the steam utilized in this decontamination process generates moisture which does not enable the apparatus to be placed back in service promptly. However, it also involves an extractant, surfactant, and relies on the formation of condensation to occur to remove contaminants.

Hence, there is a need for an improved method to remove the contaminants from a vehicle. More specifically, a method to remove the contaminants from the firefighter vehicle without using any chemical, extractant, or surfactant means.

### SUMMARY OF THE INVENTION

The present invention relates to a method for removal of contaminants from interiors of a vehicle. Specifically, the invention relates to removing toxic contaminants from a firefighter vehicle using dry steam. The method further involves spraying of the dry steam on the contaminants thereby lifting the particulates off the surface of the vehicle and into the liquid forming a carcinogenic suspension. A vacuum suction unit then removes the emulsified product from the interior of the vehicle resulting in a carcinogenic free surface.

Other objectives and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The invention will now be described, by way of example, with reference to the accompanying drawings, in which:

FIG. 1 is a flowchart illustrates the process of removing the contaminants; and

FIG. 2 is a flowchart illustrates the process of forming decontaminated product

Like reference numerals refer to like parts throughout the various views of the drawings.

### DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Research suggests that firefighters are highly likely to be exposed to substances causing cancer. This has been attributed to contaminants discharged from burning materials at the scene of fire such as carcinogens and other toxic compounds. Carcinogens are substances that cause formation of cancer by damaging a person's genome and can also disrupt cellular metabolic processes. Firemen are at a higher risk of health ailments such as cancer as these contaminants are found in the fire department vehicles.

The present invention relates to a method for decontamination of a vehicle. Specifically, the invention relates to a method for removing the contaminants from the interior of firefighter vehicles.

The present invention discloses a method for removing contaminants from the interior of firefighting vehicles. More specifically, the invention relates to the removal of contaminants such as polycyclic aromatic hydrocarbon (PAH) and other carcinogens or other toxic compounds. The fire department vehicles are sterilized to remove the cancer-causing toxic substances by spraying a dry steam in interior of the vehicle. Dry steam emulsifies the contaminants forming a suspended product. Furthermore, a vacuum suction unit is used to remove the suspended product. This method brings the contamination level of carcinogen or other toxic compound in the vehicle from a concentrated level to a non-detectable level. It helps in minimizing exposure of fire fighters to life threatening carcinogens.

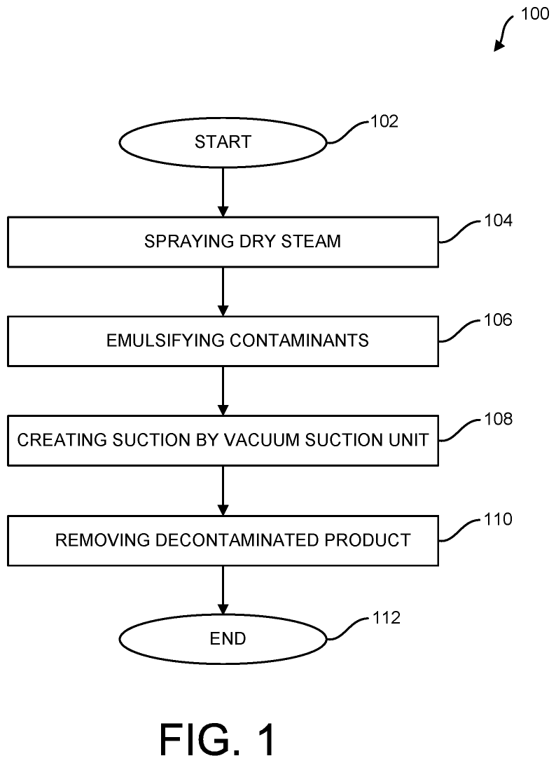

FIG. 1 illustrates a method according to the present invention for cleaning the interior of a firefighter vehicle. The method includes step 104 of spraying a dry steam in the interior of the vehicle. The spraying is performed through a known type of sprayer such as, but not limited to, a mist sprayer, a backpack sprayer, a knapsack type sprayer or a bucket type sprayer. Preferably, the sprayer is a hand-held sprayer. The hand-held sprayer is used to spray to a specific amount of gas within the interior of the firefighting vehicle.

The sprayer includes a water tank for storing water. The sprayer includes trigger lever which activates a small pump. The dry steam is generated from the water stored in the reservoir through a power source. The power source can include a switch and a light to indicate whether steam temperature is appropriate for use or not. The sprayer can be of circular, cylindrical or rectangular shape.

The dry steam sprayed in step 104 is used for emulsification process 106. Dry Steam is a steam which is slightly superheated. Superheating is not sufficient to change its energy appreciably but is a sufficient rise in temperature to avoid condensation and moisture problems. Dry steam is sprayed on contaminated areas of the firefighting vehicle. Dry steam doesn't generate moisture but allows for the contaminates to emulsify with and become suspended by the dry steam.

Once emulsified, a suspended product is formed. A vacuum suction unit is used to create suctioning effect 108 for removing the suspended product. The vacuum suction unit can be vacuum dryer, vacuum tank, vacuum cleaner, or any other suctioning device. The vacuum suction unit can be of any shape such as handheld, canister, upright, stick or autonomous/robot. Moreover, the vacuum suction unit allows for the extraction of the contaminants 110 in its suspended state.

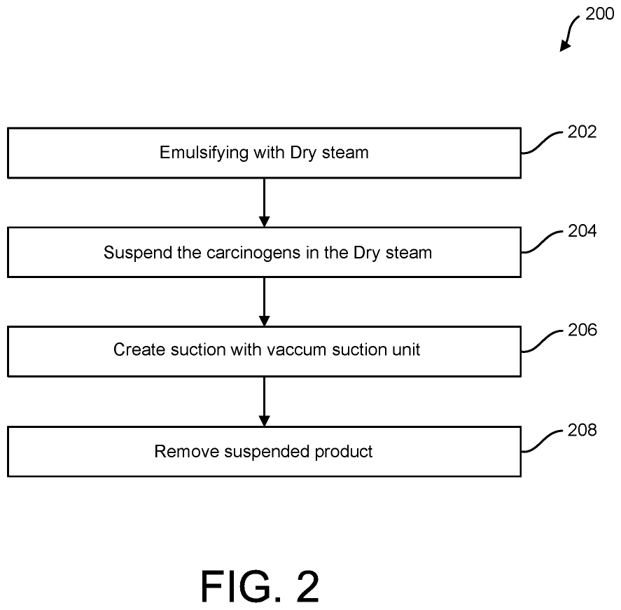

FIG. 2 illustrates a process of emulsifying contaminants 202 such as carcinogens and other toxic compounds with a dry steam. Dry steam is sprayed on the contaminants present in the interior of the vehicle. The contaminants are emulsified in dry steam resulting in the suspension of the contaminants 204. The emulsification process of mixing two substances that do not completely homogenize together help form an easily removable suspended product. The lower moisture levels due to dry steam allow the better control of the emulsified contaminants by entrapping the contaminants into the dry steam allowing for the separating of the dry steam from the surface to also remove the contaminants.

This is possible because the emulsification process binds the contaminant without spreading them to other surfaces or contaminating the immediate surroundings. The contaminants can be any type of cancer-causing agents, toxic compounds, harmful gases, carcinogens such as asbestos, nickel, cadmium, radon, vinyl chloride, benzidine, and benzene etc. Specifically, the contaminants are cancer-causing carcinogens.

The suspended product resulting from the emulsification process 204 additionally restricts the carcinogenic effects of the contaminant from spreading outside the vehicle. The vehicle can be motor vehicles, rail vehicles, aircraft, or any vehicle exposes to carcinogens. Specifically, the process is optimal for fire trucks or firefighting vehicles, firefighting gear, equipment, and SCBA regulator components. After emulsification of the contaminant, a suspended product is formed, and a vacuum suction unit is used to remove the suspended product 208.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

1. A method for removing contaminants from an object, the method comprising:
spraying an amount of dry steam onto the object;
emulsifying the contaminants with the dry steam to form a suspended product; and
removing the suspended product from the object with a vacuum suction unit.

2. The method according to claim 1, wherein contaminants are either carcinogens or toxic compounds.

3. The method according to claim 1, wherein the object is a vehicle.

4. The method according to claim 3, where in the vehicle is a fire department vehicle.

5. The method according to claim 1, wherein the object is a firefighting equipment.

6. The method according to claim 1, wherein the object is a SCBA regulator component.

7. The method of according to claim 1, wherein vacuum suction unit is a vacuum cleaner.

8. The method of according to claim 7, wherein the vacuum suction unit is configured to create suction at a pressure sufficient to remove the suspended product.
